(19) United States
(12) Patent Application Publication
(10) Pub. No.: US 2015/0061280 A1
(43) Pub. Date: Mar. 5, 2015

(54) SECURITY DEVICE

(71) Applicant: INNOVIA SECURITY PTY LTD., Craigieburn, Victoria (AU)

(72) Inventor: Gary Fairless Power, Greenvale (AU)

(73) Assignee: INNOVIA SECURITY PTY LTD, Craigieburn, Victoria (AU)

(21) Appl. No.: 14/351,973

(22) PCT Filed: Oct. 17, 2012
(86) PCT No.: PCT/AU2012/001255

§ 371 Date: Apr. 15, 2014

(30) Foreign Application Priority Data
Oct. 19, 2011 (FR) 11 59424

(51) Int. Cl. B42D 25/351; B42D 25/425; B42D 25/41; B42D 25/405

(52) U.S. Cl. CPC B42D 25/351; B42D 25/405; B42D 25/425; B42D 25/41
USPC 283/85; 29/592; 264/1.36

(57) ABSTRACT

An optical security device (10; 700) is provided which includes a transparent or translucent substrate (15; 705), at least one first array of repeating elements (20; 720) in or on a first side (16; 706) of the substrate (15; 705), at least one second array of repeating elements (30; 730) on a second side of the substrate. The second array of repeating elements (20; 720) is substantially in register with the first array of elements (30; 730), whereby a first image (130; 725) is visible when viewing the device from the first side, and a second image (200; 735) is visible when viewing the device from the second side. The brightness or colour levels of repeating image elements (30; 720, 730) on at least one side of the substrate may be modulated region-wise to produce a greyscale or coloured image. In one embodiment, the first array of repeating elements in or on a first side of the substrate is an array of focussing elements (20), and the second array of repeating elements in or on the second side of the substrate is an array of image elements (30) having substantially identical shape to each other, such that, when viewing the device from the first side, a magnified image including at least one magnified version of the image element shape is visible, and when viewing the device from the second side, the greyscale or coloured image is visible. In another embodiment, the repeating elements of both the first and second arrays are partially or fully opaque image elements (720, 730) which respectively form the first and second images (725;735).

### FIELD OF THE INVENTION

The present invention relates to optical security devices, their use in security documents, and methods of their manufacture.

### DEFINITIONS

Security Document

As used herein, the term security document includes all types of documents and tokens of value and identification documents including, but not limited to the following: items of currency such as banknotes and coins, credit cards, cheques, passports, identity cards, securities and share certificates, driver's licences, deeds of title, travel documents such as airline and train tickets, entrance cards and tickets, birth, death and marriage certificates, and academic transcripts.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that

L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Focal Point Size or Focal Point Width H

As used herein, the term focal point size (or focal point width) refers to the dimensions, usually an effective diameter or effective width, of the geometrical distribution of points at which rays refracted through a lens intersect with an object plane at a particular viewing angle. The focal point size may be inferred from theoretical calculations, ray tracing simulations, or from actual measurements.

Focal Length f

In the present specification, focal length, when used in reference to a microlens in a lens array, means the distance from the vertex of the microlens to the position of the focus given by locating the maximum of the power density distribution when collimated radiation is incident from the lens side of the array (see T. Miyashita, “Standardization for microlenses and microlens arrays” (2007) Japanese Journal of Applied Physics 46, p 5391).

Gauge Thickness t

The gauge thickness is the distance from the apex of a lenslet on one side of the transparent or translucent material to the surface on the opposite side of the translucent material on which the image elements are provided which substantially coincides with the object plane.

Lens Frequency and Pitch

The lens frequency of a lens array is the number of lenslets in a given distance across the surface of the lens array. The pitch is the distance from the apex of one lenslet to the apex of the adjacent lenslet. In a uniform lens array, the pitch has an inverse relationship to the lens frequency.

Lens Width W

The width of a lenslet in a microlens array is the distance from one edge of the lenslet to the opposite edge of the lenslet. In a lens array with hemispherical or semi-cylindrical lenslets, the width will be equal to the diameter of the lenslets.

Radius of Curvature R

The radius of curvature of a lenslet is the distance from a point on the surface of the lens to a point at which the normal to the lens surface intersects a line extending perpendicularly through the apex of the lenslet (the lens axis).

Sag Height s

The sag height or surface sag s of a lenslet is the distance from the apex to a point on the axis intersected by the shortest line from the edge of a lenslet extending perpendicularly through the axis.

Refractive Index n

The refractive index of a medium n is the ratio of the speed of light in vacuo to the speed of light in the medium. The refractive index n of a lens determines the amount by which light rays reaching the lens surface will be refracted, according to Snell's law:

n₁*Sin(α)=n*Sin(θ),

where α is the angle between an incident ray and the normal at the point of incidence at the lens surface, θ is the angle between the refracted ray and the normal at the point of incidence, and n₁ is the refractive index of air (as an approximation n₁ may be taken to be 1).

Conic Constant P

The conic constant P is a quantity describing conic sections, and is used in geometric optics to specify spherical (P=1), elliptical (0<P<1, or P>1), parabolic (P=0), and hyperbolic (P<0) lens. Some references use the letter K to represent the conic constant. K is related to P via K=P−1.

Lobe Angle

The lobe angle of a lens is the entire viewing angle formed by the lens.

Abbe Number

The Abbe number of a transparent or translucent material is a measure of the dispersion (variation of refractive index with wavelength) of the material. An appropriate choice of Abbe number for a lens can help to minimize chromatic aberration.

### BACKGROUND TO THE INVENTION

The present invention seeks to provide a security device which has an attractive appearance that may be manufactured economically while also providing an enhanced resistance to counterfeiting.

It is known to employ arrays of microlenses arranged to focus on corresponding arrays of identical microimages in order to produce optically variable effects. A particularly striking effect can be obtained by a slight misregistration of the microlenses and microimages, so that a series of moiré fringes is produced. The moiré fringes take the form of enlarged versions of the microimages. This effect, known as “moiré magnification”, has previously been described by Hutley et al (Pure and Applied Optics 3, pp 133-142, 1994) and by Amidror (“The Theory of the Moire Phenomenon”, Kluwer, Dordrecht, 2000).

The use of a transparent or translucent material as the substrate for a security device or security document makes such substrates suitable as a vehicle for devices of the type described above. For example, the microimages can be applied to one side of the substrate, and the microlenses applied to the opposite side of the substrate, which thereby acts as an optical spacer, as described for example in U.S. Pat. No. 5,712,731.

An alternative way of producing a security device or security document exhibiting a moire magnification effect is to provide a separate screen in the form of an array of microlenses. The screen can be a standalone element, or can be incorporated as part of the security device or document and brought into register with the microimages, which are located elsewhere on the document, by folding the document.

### SUMMARY OF THE INVENTION

In accordance with a first aspect of the present invention, there is provided an optical security device, including:

a transparent or translucent substrate,

at least one first array of repeating elements in or on a first side of the substrate,

at least one second array of repeating elements on a second side of the substrate,

wherein the at least one second array of repeating elements is substantially in register with the at least one first array of elements,

and wherein a first image is visible when viewing the device from the first side, and a second image is visible when viewing the device from the second side.

Preferably, the repeating elements on at least one side of the substrate are modulated region-wise according to the brightness or colour levels of corresponding regions of an input greyscale or coloured image.

In one embodiment, the repeating elements on at least one side of the substrate may be amplitude-modulated. In another embodiment, the thickness or surface area of the repeating elements on at least one side of the substrate may be modulated.

At least one of the first and second images may be optically variable. In one embodiment, the first image may be an optically variable image and the second image may be an optically invariable image.

In another embodiment, both the first and second images are optically invariable images.

The optical security device may include two or more arrays of repeating elements on or in at least one side of the substrate.

The repeating elements on at least one side of the substrate may be embossed elements. In one embodiment, the embossed elements on at least one side of the substrate form repeating image elements. In this case, each embossed image element has a depth, and the depth is preferably modulated region-wise.

The repeating elements on at least one side of the substrate may be printed image elements. In another embodiment, the repeating elements on both sides of the substrate are printed image elements.

The repeating elements on at least one side of the substrate may be diffractive or sub-wavelength structures forming image elements. The diffractive or sub-wavelength structures may be surrounded by a non-diffractive background.

In a further embodiment, the repeating elements on at least one side of the substrate are non-diffractive image elements surrounded by a background area comprising a diffractive or sub-wavelength grating structure, and a background region of the image on that side of the substrate exhibits a coloured optically variable effect.

In one preferred embodiment, the at least one first array of repeating elements in or on a first side of the substrate is an array of focussing elements, and the at least one second array of repeating elements in or on the second side of the substrate is an array of image elements having substantially identical shape to each other, wherein the image elements of the at least one second array are modulated region-wise according to the brightness or colour levels of corresponding regions of an input greyscale or coloured image, such that, when viewing the device from the first side, a magnified image including at least one magnified version of the image element shape is visible, and when viewing the device from the second side, the greyscale or coloured image is visible.

According to second aspect, the present invention provides an optical security device, including:

a transparent or translucent substrate,

an array of focussing elements in or on a first side of the substrate, and

at least one array of repeating image elements having substantially identical shape to each other and being arranged in or on a second side of the substrate,

wherein the array of repeating image elements is substantially in register with the array of focussing elements,

and wherein the image elements are modulated region-wise according to the brightness or colour levels of corresponding regions of an input greyscale or coloured image,

such that, when viewing the device from the first side, a magnified image including at least one magnified version of the image element shape is visible, and when viewing the device from the second side, the greyscale or coloured image is visible.

Preferably, the image elements are amplitude-modulated. In a preferred form of the invention, the amplitude modulation is performed by varying the line thicknesses or surface areas of the image elements.

Alternatively, the image elements may be frequency-modulated. For example, the repeating image elements may have substantially the same overall period as the array of focussing elements, but may be omitted in some areas so as to produce variations in brightness when the second side of the device is viewed. This may result in slightly degraded magnified image quality but improved contrast for viewing of the greyscale or coloured image.

The effect produced by the security device thus includes a moire magnification effect when the device is viewed from the first side, while the device (unexpectedly for a transparent area) produces a completely different optical effect, such as an optically invariable image (for example, a portrait), when the device is viewed from the opposite side. This combination of two different types of optical effect within the same area of the device provides a more recognisable security feature with enhanced security over known security devices.

The device also has increased ease of manufacture, since an array of image elements in a single surface of the device, and applied in a single manufacturing step (for example, by embossing), can be used to produce the two different effects.

In one particularly preferred embodiment, the magnified image is an optically variable image and the greyscale or coloured image is an optically invariable image.

A monochromatic macroscale image may be produced through the interaction of diffractive and non-diffractive elements. In lighting conditions with multiple or diffuse light sources, the image appears as a negative (contrast-inverted) representation of the input image in reflection, and as a positive representation of the input image in transmission. Usually a purely diffractive device under such lighting conditions would produce a very weak image of low diffraction efficiency, in some circumstances being so weak as to not be recognisable at all.

The optical security device may include two or more arrays of repeating image elements. Thus, for example, one magnified image may be visible when viewing a first region of the device from the first side, whilst a second, different, magnified image is visible when viewing a second region of the device from the first side. When the device is viewed from the second side, a tonal greyscale or colour image is visible. The addition of further arrays of repeating image elements thus adds to the complexity of the visual effect produced by the device, further increasing the difficulty to the counterfeiter.

In one preferred embodiment, the focal point width of the focussing elements in an object plane located at the second side of the device is approximately the same as, or within 20% of, the width of the image elements. This permits larger image elements to be used with a given substrate thickness, whilst still providing the desired magnified image effect.

Preferably, the magnification of the image elements in the magnified image is controlled by a pitch difference and/or rotational misalignment between the array of focussing elements and the array of image elements.

In one embodiment, the image elements are embossed image elements, but the image elements may also be printed image elements. Embossed image elements are particularly preferred because of the higher resolution achievable with embossing processes, leading to a sharper magnified image when the device is viewed from the first side. In one method of applying amplitude modulation to the image elements, each embossed image element has a depth, and the depth is modulated region-wise.

Printing techniques may also be used, provided the resolution of the print is sufficiently high for the image elements to be accommodated under the focussing elements.

In one particularly preferred embodiment, the image elements comprise diffractive or sub-wavelength grating elements surrounded by a non-diffractive background area, wherein the magnified image exhibits a coloured optically variable effect. Alternatively, the image elements may be non-diffractive image elements surrounded by a background area comprising diffractive or sub-wavelength grating elements, wherein a background region of the magnified image exhibits a coloured optically variable effect.

A “sub-wavelength” or zero-order grating element is a surface-relief or buried microstructure which produces light in only the zero diffraction order under illumination by light of a given wavelength. Generally, such zero-order structures have a periodicity which is less than the desired wavelength of incident light. For this reason, zero-order diffraction gratings are sometimes also known as sub-wavelength gratings.

The use of diffractive or sub-wavelength image elements (or non-diffractive image elements on a diffractive background) advantageously provides a device which produces a striking visual effect under both specular reflection and diffuse or low-light conditions.

The focussing elements may be refractive microlenses. Alternatively, they may be Fresnel lenses, diffractive zone plates, or photon sieves. An exemplary photon sieve is one in which a series of apertures is pseudo-randomly distributed along the Fresnel zones of a Fresnel zone plate, as described for example in U.S. Pat. No. 7,368,744.

In another preferred embodiment of the first aspect of the invention, the at least one first array of repeating elements in or on the first side are image elements forming a first image, the at least one second array in or on the second side are image elements forming a second image, the image elements of at least one of the first and second arrays of repeating elements are at least partially opaque, whereby the first image is visible when viewing the device in reflection from the first side, and the second image is visible when viewing the device in reflection from the second side.

In accordance with a third aspect of the invention, there is provided an optical security device, including:

a transparent or translucent substrate,

at least one first array of repeating image elements in or on a first side of the substrate forming a first image,

at least one second array of repeating image elements on a second side of the substrate forming a second image,

wherein the at least one second array of repeating image elements is substantially in register with the at least one first array of repeating image elements, and

the at least one first array and/or the at least one second array of repeating image elements is at least partially opaque,

whereby the first image is visible when viewing the device in reflection from the first side, and the second image is visible when viewing the device in reflection from the second side.

Preferably, the image elements of both the first and second arrays are at least partially opaque. The image elements of at least one of the arrays may be fully opaque. In one embodiment, the image elements of at least one of the arrays are partially opaque and partially transparent so that the first and second images combine to form a third image which is visible when the security device is viewed in transmission.

The image elements of at least one of the first and second array may be coloured image elements which are modulated region-wise according to the colour or brightness levels of corresponding regions of an input coloured image.

Alternatively, or additionally, the image elements of at least one of the first and second array may be greyscale image elements which are modulated region-wise according to the brightness levels of corresponding regions of an input greyscale image.

The image elements on at least one side of the substrate may be printed image elements. The image elements on both sides of the substrate may be printed image elements. Alternatively, the image elements on at least one side of the substrate may be embossed image elements. In other embodiments, the image elements on at least one side of the substrate may be diffractive structures or sub-wavelength structures.

In a further embodiment, the repeating image elements on at least one side of the substrate are non-diffractive image elements surrounded by a background area comprising a diffractive or sub-wavelength grating structure, wherein a background region of the image visible when viewing the device from that side exhibits a coloured optically variable effect.

In a fourth aspect of the invention, there is provided a method of manufacturing a security device, including the steps of:

forming at least one first array of repeating elements in or on a first side of a transparent or translucent substrate; and

forming at least one second array of repeating elements in or on a second side of the substrate,

wherein the at least one second array of repeating elements is substantially in register with the at least one first array of repeating elements,

such that, when viewing the device from the first side, a first image is visible, and when viewing the device from the second side, a second image is visible.

Preferably, the method includes the step of modulating the repeating elements on at least one side of the substrate region-wise according to the brightness or colour levels of an input greyscale or coloured image.

The method preferably includes the step of printing the repeating elements on at least one side of the substrate to form repeating image elements. In one embodiment, the method includes the step of printing the repeating elements on both sides of the substrate to form repeating image elements. Various printing methods may be used to print the repeating image elements, including offset printing, flexographic printing, intaglio printing and gravure printing. Simultan printing is a particularly preferred printing method which may be used to form repeating image elements in register on opposite sides of a substrate simultaneously.

The method may include the step of forming the repeating elements on at least one side of the substrate as diffractive image elements.

The method may include the step of embossing the repeating elements on at least one side of the substrate.

In a particularly preferred method, the steps of forming the at least one first array of repeating elements and forming the at least one second array of image elements are performed substantially simultaneously.

In a fifth aspect, the present invention provides a method of manufacturing a security device, including the steps of:

forming an array of focussing elements in or on a first side of a transparent or translucent substrate; and

forming at least one array of repeating image elements having substantially identical shape to each other and being arranged in or on a second side of the substrate,

wherein the array of repeating image elements is substantially in register with the array of focussing elements,

and wherein the image elements are modulated region-wise according to the brightness levels of corresponding regions of an input greyscale or coloured image,

such that, when viewing the device from the first side, at least one magnified version of the image element shape is visible, and when viewing the device from the second side, the greyscale or coloured image is visible.

The method may further include the step of applying an embossable radiation-curable ink to the first side and/or the second side.

Preferably, the method further includes the step of forming the focussing elements in the embossable radiation-curable ink in the first side by embossing. The method may also include the step of forming the image elements in the embossable radiation-curable ink in the second side by embossing.

Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

The type of primer may vary for different substrates and embossed ink structures. Preferably, a primer is selected which does not substantially affect the optical properties of the embossed ink structure.

The steps of forming the array of focussing elements and forming the array of image elements are preferably performed sequentially. However, in some embodiments, for example when the focussing elements and image elements are applied by embossing, the steps may be performed simultaneously.

The method may further include the step of curing the embossable radiation-curable ink. This is preferably performed substantially simultaneously with the embossing step.

In one preferred embodiment, the image elements comprise diffractive or sub-wavelength grating elements surrounded by a non-diffractive background area. Alternatively, the image elements may be non-diffractive image elements surrounded by a background area comprising diffractive or sub-wavelength grating elements.

The image elements may be formed by printing or embossing the image element shape as a non-diffractive structure on a background of diffractive or sub-wavelength grating elements. Alternatively, the image elements may be formed by embossing diffractive or sub-wavelength grating elements on a non-diffractive background.

In a further aspect, there is provided a security document including a security device according to the first second or third aspects of the invention, or a security device manufactured according to the fourth or fifth aspects of the invention. The security device may be formed in, or applied to, a window of the security document.

### BRIEF DESCRIPTION OF THE DRAWINGS

Preferred embodiments of the invention will now be described with reference to the accompanying drawings, in which:

FIG. 1 is a cross-section through one embodiment of a security device according to the invention;

FIG. 2 shows the security device of FIG. 1 as part of a security document;

FIG. 3 shows a series of image elements for use with a security device according to an embodiment of the invention;

FIG. 4 shows the image elements of FIG. 3 as viewed through an array of focussing elements;

FIGS. 5 and 6 show a variation of the embodiment of FIGS. 3 and 4;

FIG. 7 shows a further embodiment of a security device in which the image elements have been printed;

FIG. 8 shows an optically invariable image which is visible to a person viewing the security device of FIG. 3 from the side opposite the array of focussing elements; and

FIG. 9 shows an embodiment of an apparatus suitable for manufacturing security devices or security documents according to the above embodiments;

FIG. 10 shows a schematic sectional view of a security device in accordance with another embodiment of the invention;

FIG. 11 is a schematic sectional view of a security document with the security device of FIG. 10 in a window of the document;

FIG. 12 shows the security document of FIG. 11 with a first image visible when viewed in reflection from a first side;

FIG. 13 shows the security document of FIG. 11 with a second image visible when viewed in reflection from the second side;

FIG. 14 shows an enlarged view of the window area and security device of the security document of FIG. 12;

FIG. 15 shows an enlarged view of the window area and security device of the security document of FIG. 13; and

FIG. 16 shows a modified embodiment to the security document of FIGS. 12 and 15 with a third image visible when viewed in transmission.

### DESCRIPTION OF PREFERRED EMBODIMENTS

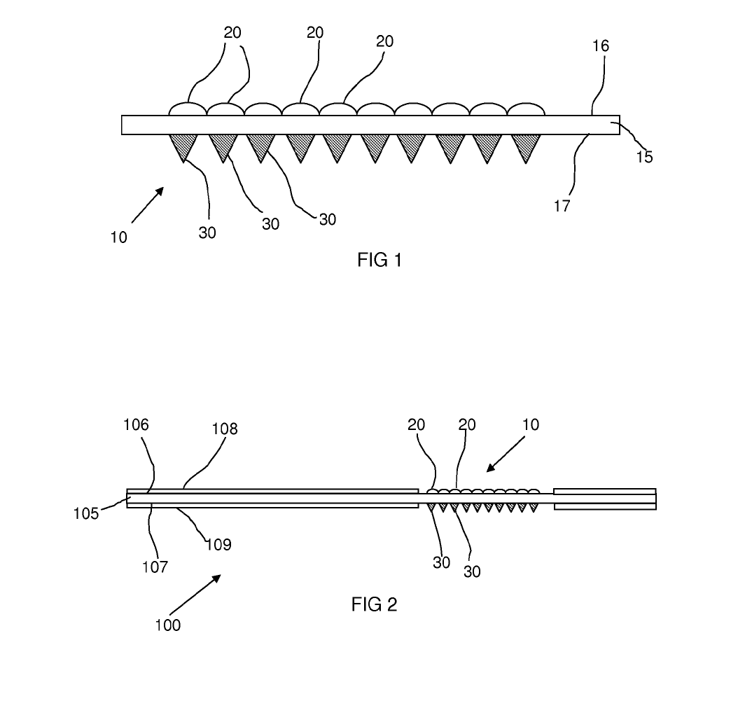

In FIG. 1, there is shown a partial cross-section through a security device 10 having a transparent or translucent substrate 15 having a first side 16 and a second side 17. An array of focussing elements in the form of part-spherical microlenses 20 is formed on the first side 16, and a corresponding array of repeating image elements 30 is formed on the second side 17.

The focussing elements 20 may be formed directly in the surface of the first side 16 of the substrate 15, but are preferably formed in an embossable radiation curable ink which is applied to the first side 16, for example by gravure printing.

Image elements 30 may be printed image elements, being applied for example by flexographic printing to the surface of second side 17. Preferably, though, they are embossed image elements which are formed by applying an embossable radiation curable ink to the second side 17, embossing an array of relief structures into the embossable radiation curable ink, and curing the ink.

FIG. 2 is a partial cross-section through a security document 100 which includes the security device 10. The security document includes a transparent or translucent substrate 105 having a first side 106 and a second side 107. Layers of opacifying ink 108, 109 are applied to first side 106 and second side 107 respectively, apart from in a window region in which the security device 10 is situated. The opacifying ink 108, 109 is preferably applied before forming the security device 10 in the window area, for greater ease of registering the security device 10 with the window region.

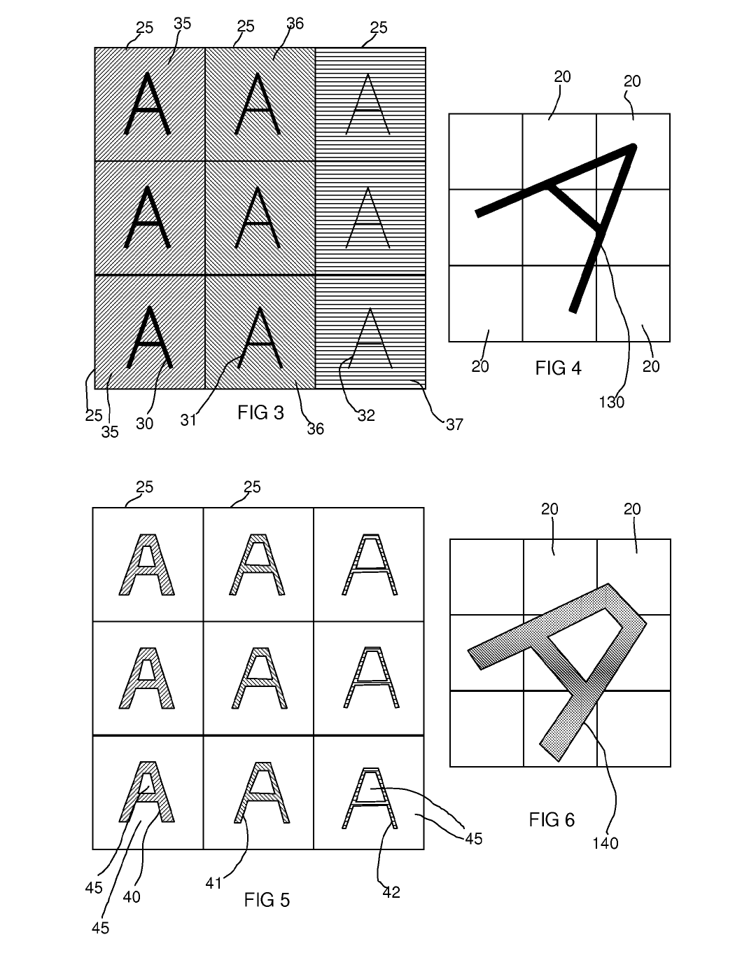

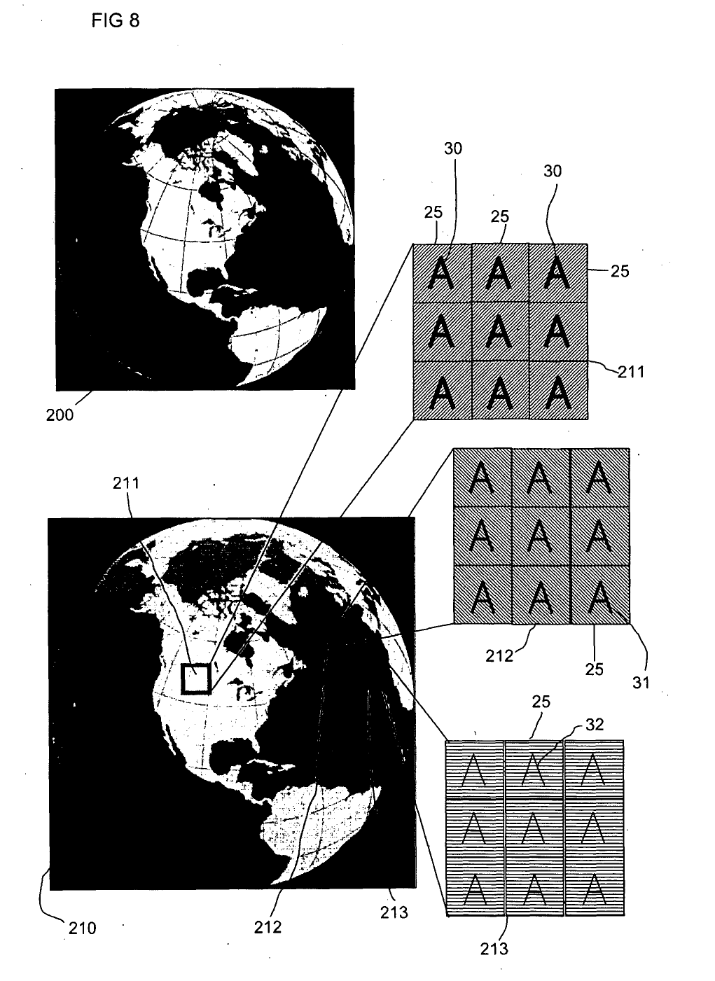

Referring now to FIGS. 3, 4 and 8, further details of the security device 10 are shown. The array of image elements 30 to be applied to the second side 17 of device 10 is generated by creating a dithered or halftoned version of an input image 200. In the example shown in FIG. 8, each pixel of the monochromatic bitmap 200 is mapped to one of three brightness levels, each brightness level corresponding to a particular line thickness for the image elements (amplitude modulation) as shown at right in the magnified views of regions 211, 212, 213 of image element array 210. In an alternative embodiment, the spatial distribution of image elements 30 on the second side 17 of the substrate could be modulated according to the brightness levels of input image 200 (frequency modulation), but amplitude modulation is preferred.

Each image region 211, 212, 213 comprises pixels 25 which are square areas having dimensions corresponding to the dimensions of overlying part-spherical lenses 20. Pixels 25 will generally be of the order of 45 microns square to 65 microns square, though it will be appreciated that larger or smaller dimensions can be chosen to suit the particular application. It will also be appreciated that the pixels need not be square, but in many applications it is convenient to choose square pixels.

Image region 211 corresponds to part of the brightest region of input image 200 and as such, includes embossed image elements 30 which produce the greatest amount of reflected or transmitted light, i.e. have the greatest line thickness. Image region 212 lies within the next brightest part of image 200, and so its image elements 31 have a slightly reduced line thickness compared to image elements 30. Similarly, image region 213 which lies within the darkest areas of input image 200 has image elements 32 having the least line thickness.

Image elements 30, 31, 32 are all of substantially the same shape, and differ only in their line thickness. The line thickness can be modulated to the extent permitted by the resolution of the process used to apply the image elements. For flexographic printing, the smallest resolution is approximately 7 microns. For an embossing process, the smallest resolution is limited by the resolution of the electron beam or other process used to create the embossing master, and can be of the order of nanometres. Embossing processes are thus preferred because they allow a finer gradation between line thicknesses, and hence brightness levels, thus producing the impression of a smooth transition between areas of differing colour or brightness.

The array of lenses 20 and the array of image elements 30, 31, 32 can be made to produce a moire-magnified image when the two arrays have slightly different pitches or are rotationally misaligned. The degree of magnification for a lens array of period a and an image element array of period b is given by a²/Δ, where Δ=a−b is the pitch difference. If the lens array and image array have identical periods a, but have axes which are at an angle θ to each other, the magnification is approximately 1/(1−cos θ).

The 3×3 grid of pixels 25 in FIG. 3 includes three of each image element 30, 31 and 32. Each image element 30, 31 or 32 is an embossed or printed non-diffractive element surrounded by an area 35, 36 or 37 respectively which comprises an embossed surface relief structure. The surface relief structures in background areas 35, 36 and 37 may have the same parameters (depth of embossing, spatial frequency, curvature, azimuthal angle) as each other, or the surface relief parameters may vary between regions if desired.

It will also be appreciated that the image elements 30-32 may be formed by unembossed regions of pixels 25, that is to say, the entirety of a pixel 25 is embossed apart from a region having a boundary with the shape of the image element 30, 31 or 32.

The surface relief structure may be diffractive so as to produce a brightly coloured background area which changes with observation angle. Alternatively, the surface relief structure may be a sub-wavelength (zero order) grating having a particular colour at all observation angles. Advantageously, sub-wavelength structures generally also produce strong polarisation effects, and so varying (for example) the azimuthal angle of the relief structure between pixels can result in a further authentication feature which can be viewed under polarising filters.

The optical effects produced by the device 10 of FIGS. 1, 3, 4 and 8 are as follows.

When the device 10 is viewed from the first side 16 of the substrate 15, at least one magnified and rotated version 130 of the individual image elements 30, 31, 32 is seen due to the moiré magnification effect produced by lenses 20. Although image elements 30, 31, 32 are not exactly identical, they can be made to differ in line thickness by a sufficiently small degree such that the collective effect produced by sampling of individual image elements by lenses 20 is an “average” of the individual sampled images. The image may also appear to float above or below the plane of the device 10, and/or exhibit orthoparallactic motion as the device is 10 tilted backwards and forwards or side-to-side by the viewer. If diffractive background areas 35, 36 and 37 are used, the magnified images 130 may also have a brightly coloured and optically variable background.

When the device 10 is viewed from the second side 17 of substrate 15, the individual image elements 30, 31, 32 are not magnified, and being of a dimension which is too small to be perceived by the naked eye (preferably of the order of 150 microns or less, more preferably less than 70 microns, so as to be imperceptible at a viewing distance of 20 cm), collectively produce the impression of a monochromatic or coloured image 200.

The device 10 thus counter-intuitively produces an optically variable, magnified floating or moving image when viewed from the first side 16, and an optically invariable, tonal monochromatic or full-colour image when viewed from the second side 17, of the transparent or translucent substrate 15.

FIGS. 5 and 6 show an alternative embodiment in which embossed image elements 40, 41 and 42 within pixels 25 are surrounded by non-diffractive areas 45. The image elements 40, 41 and 42 have different thicknesses, and in this embodiment, also comprise diffractive or sub-wavelength surface relief structures. The surface relief structures may have identical parameters in each image element (depth of embossing, spatial frequency, curvature, azimuthal angle), or the parameters may vary from pixel to pixel or between different thicknesses of image element. The embodiment of FIGS. 5 and 6 produces, when viewed through lenses 20, at least one magnified and rotated version 140 of the individual image elements 40, 41, 42 which is also coloured according to the colour of the individual image elements being sampled. As for FIGS. 3 and 4, when viewed from the second side 17 of transparent or translucent substrate 15, the device of FIGS. 5 and 6 exhibits an optically invariable, tonal monochromatic or full-colour image as shown in FIG. 8.

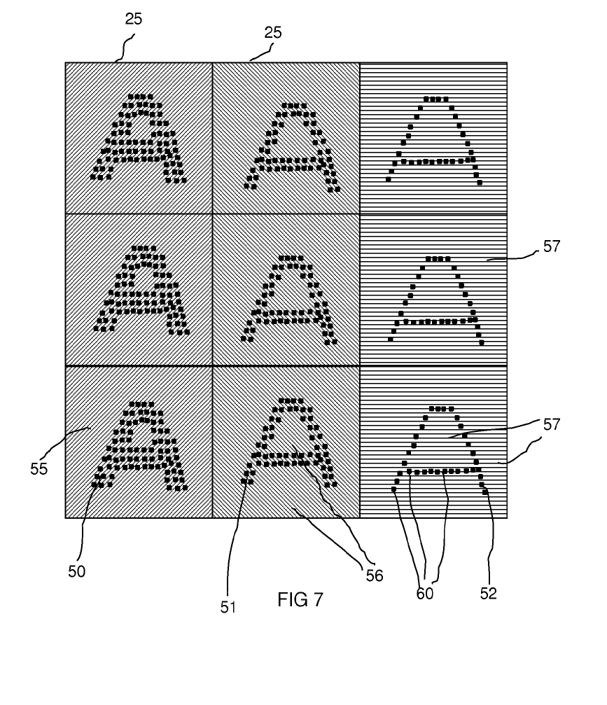

FIG. 7 shows part of a further embodiment of a device produced by flexographic printing, in which a 3×3 grid of pixels 25 includes image elements 50, 51, 52 composed of flexographic dots 60 and being surrounded by diffractive background regions 55, 56, 57 respectively. The image elements 50, 51, 52 have substantially the same shape (of a letter ‘A’), but differ in the number of flexographic dots from which they are composed.

As for the embodiments of FIGS. 3 and 5, when viewed from the second side 17 of transparent or translucent substrate 15, the device exhibits an optically invariable, tonal monochromatic or full-colour image as shown in FIG. 8.

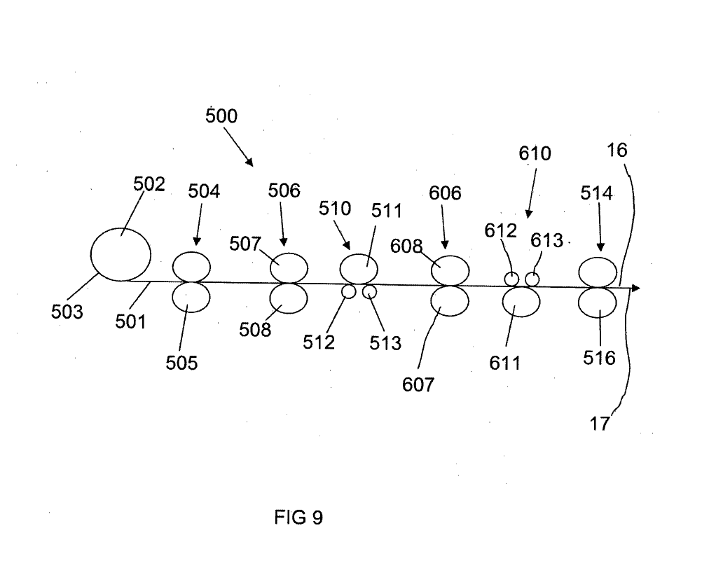

Referring now to FIG. 9, there is shown one embodiment of an apparatus for manufacturing security documents including devices of the above type.

The printing and embossing apparatus 500 shown schematically in FIG. 9 includes supply unit 502 for supplying a sheet-like substrate 501 to various printing and embossing stations, including an opacifying station 504, a first printing station 506, an embossing station 510, a second printing station 606, a second embossing station 610, and a third printing station 514.

The substrate 501 is preferably made of a substantially transparent or translucent polymeric material such as biaxially oriented polypropylene (BOPP) and may be continuously supplied to the opacifying station 504 from a roll 503 of the material at the supply unit 502. The opacifying station 504 includes opacifying means for applying at least one opacifying layer to at least one side of the substrate 501. The opacifying means is preferably in the form of a printing unit, eg one or more Gravure printing cylinders 505 for applying one or more opacifying coatings of ink to one or both sides of the substrate. However, it is possible the opacifying station 504 could include opacifying means in the form of a laminating unit for applying one or more sheet-like layers of at least partly opaque material, such as paper or other fibrous material to at least one side of the transparent substrate.

Preferably, the opacifying means 505 at the opacifying station 504 is arranged to omit at least one opacifying layer on one or both sides of the substrate in at least one region to form a window or half-window area.

The first printing station 506 includes printing means 507, 508 for applying an embossable radiation-curable ink to the substrate 501. The printing means may comprise at least one printing cylinder 507, eg a Gravure printing cylinder, with the opacified transparent substrate fed between the printing cylinder 507 and a corresponding cylinder or roller 508 on the opposite side of the substrate.

The printing means 507, 508 is arranged to apply the radiation curable ink to the first side 16 of the substrate 501 on which the lenses 20 are to be embossed at the embossing station 510. The lenses may be applied in a window area formed by omitting areas of opacifying ink applied at opacifying station 504.

The embossing station 510 includes embossing means preferably in the form of a plate cylinder 511 and impression cylinder 512. The embossing means 511, 512 includes embossing portions arranged to emboss different areas of the substrate as it passes through the nip between the plate and impression cylinders 511, 512.

The embossing station 510 may also include radiation curing means 513 for curing the embossable, radiation curable ink substantially simultaneously or almost immediately after the ink has been embossed, to form the lenses 20. Alternatively, a separate curing station may be provided. The radiation curing means preferably comprises an ultraviolet (UV) curing unit for curing a UV curable ink, but other types of curing units, eg X-ray or electron beam (EB) curing units may be used for X-ray or EB radiation curable inks.

The second printing station 606 includes printing means 607, 608 for applying an embossable radiation-curable ink to the second side 17 of the substrate 501. The printing means may comprise at least one printing cylinder 607, eg a Gravure printing cylinder, with the opacified transparent substrate fed between the printing cylinder 607 and a corresponding cylinder or roller 608 on the opposite side 16 of the substrate 501. The printing means 607, 608 is arranged to apply radiation curable ink to the second side 17 of the substrate 501 at a region directly opposite and in register with the lenses 20. If the lenses 20 are applied in a window region, the radiation curable ink is applied in the window region on the opposite side of substrate 501.

The embossing station 610 includes embossing means preferably in the form of a plate cylinder 611 and impression cylinder 612. Plate cylinder 611 carries the structures of the image elements 30-32 and/or 40-42, and also, if embossed background areas 35-37, 45 or 55-57 are used, the structures of those background areas. After the substrate 501 passes through embossing station 610, it carries an array of lens structures 20 on its first surface 16, and a corresponding array of image elements 30-32 or 40-42 which is substantially in register with the array lenses 20.

The embossing station 610 may also include radiation curing means 613 for curing the embossable, radiation curable ink substantially simultaneously or almost immediately after the ink has been embossed, to form the cured embossed image elements 30-32 or 40-42.

It will also be appreciated that second printing station 606 and second embossing station 610 may be replaced by a printing station, for example a flexographic printing station, if printed image elements 50-52 are to be used.

The third printing station 514 includes printing means for applying printed features to the substrate. The printed means preferably includes a printing cylinder 516 such as a Gravure, offset or intaglio cylinder, and may be used to apply a wide variety of printed features to the substrate. For instance, the printing cylinder 516 at the second printing station 514 may be used to apply printed security features in register with, adjacent to or surrounding the embossed security element.

In operation of the apparatus, the transparent substrate 501 is supplied from the supply unit 502 through the opacifying station 504 where at least one opacifying layer is applied to at least one side of the substrate 501. The at least partly opacified substrate 501 is then fed through the first printing station 506 where the embossable radiation curable ink is applied to an area (for example, a window area) which is to be embossed to form the lenses 20.

The substrate 501 is then fed through the embossing station 510 where the previously applied area of ink is embossed to form the microlenses 20 on the first side 16 of the substrate 501. The radiation curable ink is then cured by radiation, preferably at the embossing station 510 to fix the embossed lenses 20.

Substrate 501 is fed through the second printing station 606 and second embossing station 610 in order to form embossed image elements 30-32 or 40-42 on second side 17 of substrate 501, substantially in register with embossed lenses 20.

The apparatus 500 may also include further printing stations or embossing stations (not shown) for applying further printed or embossed features to the substrate 501.

It is also possible for an opacifying station to be located after the embossing station 510, with this opacifying station applying at least one opacifying layer to at least one side of the substrate 501 except in the area of the embossed lenses 20 and embossed image elements 30-32 or 40-42 to form a window.

In some embodiments, it may also be possible to simultaneously emboss both sides of the substrate, so that the lenses 20 and image elements 30-32 or 40-42 are formed substantially in register on opposite sides of the substrate at the same time.

FIGS. 10 to 16 illustrate further embodiments of security devices and security documents in accordance with the present invention which produce different images when viewed in reflection from opposite sides of the device, and in transmission.

In FIG. 10 there is shown a partial cross-section through a security device 700 having a transparent or translucent substrate 705 having a first side 706 and a second side 707. A first array 712 of repeating elements in the form of image elements 720 is formed on the first side 706, and a second array 713 of repeating elements in the form of image elements 730 is formed on the second side 707 substantially in register with the image elements 730 of the first array 713.

The image elements 720, 730 of the first and second arrays 712, 713 are preferably formed as fine lines or dots, with spaces 721, 722 between the dots which allow the transmission of light through the transparent or translucent substrate. Where lines are used, they may be straight, curved, wavy or take other shapes. When dots are used, the dots are preferably round, but may take other regular or irregular shapes. In each case the image elements 730 of the second array 713 are preferably substantially the same shape as the image elements 720 of the first array 712, as well as being substantially in register.

The image elements 720, 730 of the first and second arrays 712, 713 are coloured or greyscale image elements which are modulated region-wise according to the colour or brightness levels of corresponding regions of an input coloured or greyscale image.

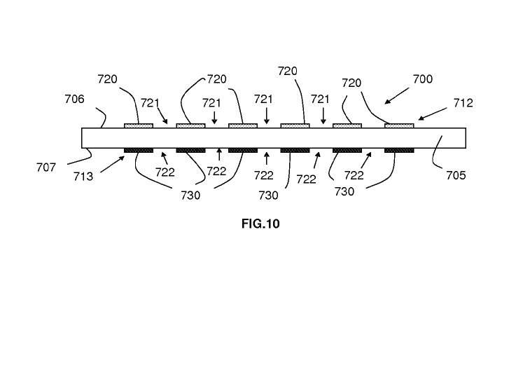

FIG. 11 is a partial cross-section through a security document 800 which includes the security device 700. The security document includes a transparent or translucent substrate 805 having a first side 806 and a second side 807. Layers of opacifying ink 808, 809 are applied to first side 806 and second side 807 respectively, apart from in a window region 810 in which the security device 700 is situated. The opacifying ink 808, 809 is preferably applied before forming the security device 700 in the window 710, for greater ease of registering the security device 700 with the window.

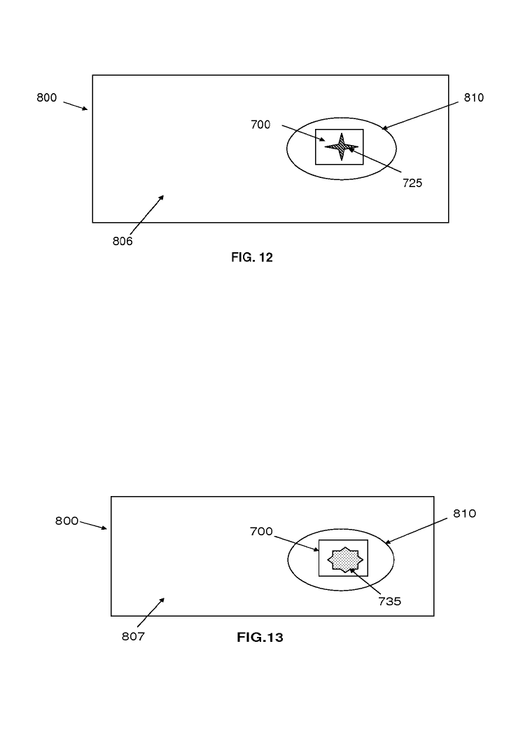

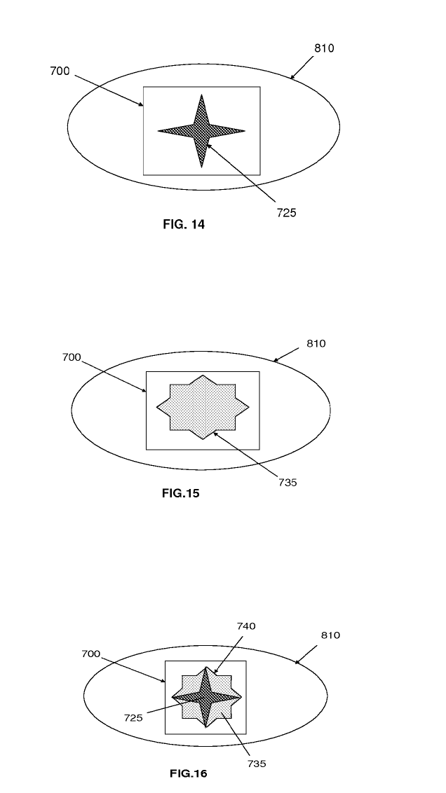

FIGS. 12 and 13 show the security document 800 when viewed in reflection from the first and second sides 806, 807 respectively. FIGS. 14 and 15 respectively show enlarged views of the window region 810 and security device 700 of the security document shown in FIGS. 12 and 13.

The image elements 720, 730 are at least partially opaque. Therefore, when the security device 700 is viewed in reflection in a substantially perpendicular direction to the plane of the substrate from the first side 806, only the image elements 720 of the first array 712 are visible so that a first coloured or greyscale image 725 formed from the image elements 720 is visible as shown in

FIGS. 12 and 14. Likewise, when the security device 700 is viewed in reflection in a substantially perpendicular direction to the plane of the substrate from the second side 807, only the image elements 730 of the first array 713 are visible so that a first coloured or greyscale image 735 formed from the image elements 730 is visible as shown in FIGS. 13 and 15.

By way of example only, FIGS. 12 and 14 show a simple black and white image 725 in the shape of a four-pointed star. Such an image may be formed by having opaque black image elements forming the star shape and opaque white image elements forming the background for the star. FIGS. 13 and 15 show a simple grey image 735 in the shape of an eight-pointed star formed by having opaque grey lines or dots forming the star shape and opaque white lines or dots forming the background for the star. However, more complex greyscale images can be formed by more complex region-wise modulation of the brightness levels of grey image elements according to the brightness levels of corresponding regions of the input greyscale image.

It is also possible to form coloured or multicoloured images by using coloured image elements with region-wise modulation of the colour or brightness levels of the coloured lines or dots according to the colour or brightness levels of corresponding regions of an input coloured image.

When substantially fully opaque image elements are used on both sides, only the first image is visible from the first side in reflection and transmission, and only the second image is visible from the second side in reflection and transmission. In other embodiments, such as illustrated by FIG. 16, it is possible for one or more additional images to be formed which are visible in transmission by using image elements on at least one of the first and second sides which are partially opaque and partially transparent or translucent to allow some transmission of light. For example, if the image elements 720 of the first array forming the four-pointed star image 725 are fully opaque and the image elements 730 of the second array forming the eight-pointed star 735 are partially opaque and partially transparent, when the device is viewed in transmission from the second side, a combined third image 740 consisting of the four-pointed star 725 and the eight-pointed star 735 will be visible, as shown in FIG. 16.

The image elements 720, 730 of one or both of the first and second arrays may be printed image elements, for example applied by flexographic or Simultan printing to a surface or surfaces of the substrate. Alternatively, the image elements 720, 730 of one or both of the first and second arrays may be embossed image elements. Embossed image elements may be formed by applying an embossable radiation curable ink to the substrate, embossing an array of relief structures into the embossable radiation curable ink, and curing the ink. For example, a translucent coloured radiation curable ink may be used to form embossed image elements which are partially transparent so that a combined image is visible in transmission from at least one side.

In a further modification, the image elements on at least one side of the substrate are diffractive image elements. Optically variable images can be formed by diffractive image elements, whereas printed image elements generally form optically invariable images. In one embodiment, the image elements of the first array may be printed images to form an optically invariable image, and the image elements of the second array may be diffractive image elements to form an optically variable image.

In a further embodiment, the image elements on at least one side of the substrate are non-diffractive image elements surrounded by a diffractive or sub-wavelength grating structure, so that a background region of the resulting image visible from that side of the substrate exhibits a coloured optically variable effect.

Diffractive image elements, or a diffractive or sub-wavelength structure, may be formed by applying an embossable radiation curable ink to a surface of the substrate, embossing the required diffractive or sub-wavelength structure into the radiation curable ink, and curing the ink.

Apparatus for manufacturing security documents similar to that described with reference to FIG. 9 may be used for manufacturing security documents including embossed or diffractive image elements or structures. When the image elements on the first and second arrays are printed elements, a simpler apparatus may be used with a Simultan printing station replacing the first and second printing and embossing stations 506, 510, 606 and 610 of FIG. 9.

1-45. (canceled)

46. An optical security device, the device comprising:
a transparent or translucent substrate;
at least one first array of repeating elements at least one of in or on a first side of the substrate; and
at least one second array of repeating elements on a second side of the substrate,
wherein:
the at least one second array of repeating elements is substantially in register with the at least one first array of elements;
a first image is visible when viewing the device from the first side;
a second image is visible when viewing the device from the second side; and
the repeating elements on at least one side of the substrate are modulated region-wise according to at least one of a brightness or a color level of corresponding regions of at least one of an input greyscale or a colored image.

47. An optical security device according to claim 46, wherein at least one of the repeating elements on at least one side of the substrate are amplitude-modulated, or the thickness or surface area of the repeating elements is modulated.

48. An optical security device according to claim 46, wherein at least one of the first and the second images is an optically invariable image.

49. An optical security device according to claim 46, wherein the repeating elements on at least one side of the substrate are selected from the group consisting of: embossed image elements, printed image elements, and diffractive image elements.

50. An optical security device according to claim 46, wherein:
the repeating elements on at least one side of the substrate are non-diffractive image elements surrounded by a background area comprising a diffractive or sub-wavelength grating structure; and
a background region of the image on the at least one side of the substrate exhibits a colored optically variable effect.

51. An optical security device according to claim 46, wherein:
the at least one first array of repeating elements in or on a first side of the substrate is an array of focusing elements, and
the at least one second array of repeating elements at least one of in or on the second side of the substrate is an array of image elements having substantially identical shape to each other, such that, when viewing the device from the first side, a magnified image including at least one magnified version of the image element shape is visible, and when viewing the device from the second side, the at least one of the greyscale or the colored image is visible.

52. An optical security device, the device comprising:
a transparent or translucent substrate;
an array of focusing elements at least one of in or on a first side of the substrate; and
at least one array of repeating image elements having substantially identical shape to each other and being arranged at least one of in or on a second side of the substrate,
wherein the array of repeating image elements is substantially in register with the array of focusing elements, such that, when viewing the device from the first side, a magnified image including at least one magnified version of the image element shape is visible, and when viewing the device from the second side, at least one of a greyscale or a colored image is visible.

53. An optical security device according to claim 52, wherein the repeating image elements on at least one side of the substrate are modulated region-wise according to at least one of a brightness or a color level of corresponding regions of at least one of an input greyscale or colored image.

54. An optical security device according to claim 52, wherein:
the image elements are non-diffractive image elements surrounded by a background area comprising a diffractive or sub-wavelength grating structure; and
at least one of a background region of the magnified image exhibits a colored optically variable effect or the image elements comprise diffractive or sub-wavelength grating structures surrounded by a non-diffractive background area; and
the magnified image exhibits a colored optically variable effect.

55. An optical security device according to claim 52, wherein the focusing elements are selected from at least one of refractive microlenses, Fresnel lenses, diffractive zone plates, or photon sieves.

56. An optical security device according to claim 52, wherein:
the at least one first array of repeating elements in or on the first side are image elements forming a first image;
the at least one second array in or on the second side are image elements forming a second image; and
the image elements of at least one of the first and second arrays of repeating elements are at least partially opaque, whereby the first image is visible when viewing the device in reflection from the first side, and the second image is visible when viewing the device in reflection from the second side.

57. An optical security device, the device comprising:
a transparent or translucent substrate;
at least one first array of repeating image elements at least one of in or on a first side of the substrate forming a first image; and
at least one second array of repeating image elements on a second side of the substrate forming a second image,
wherein:
the at least one second array of repeating image elements is substantially in register with the at least one first array of repeating image elements;
the repeating image elements on at least one side of the substrate are modulated region-wise according to at least one of a brightness or one or more color levels of corresponding regions of an input greyscale or colored image; and
the at least one first array and/or the at least one second array of repeating image elements is at least partially opaque, whereby the first image is visible when viewing the device in reflection from the first side, and the second image is visible when viewing the device in reflection from the second side.

58. An optical security device according to claim 57, wherein the image elements at least one of the first and second arrays are partially opaque and partially transparent so that the first and second images combine to form a third image which is visible when the security device is viewed in transmission.

59. An optical security device according to claim 57, wherein the image elements of at least one of the first and second array are at least one of colored or greyscale image elements which are modulated region-wise according to the color or brightness levels of corresponding regions of an input colored or greyscale image.

60. An optical security device according to claim 57, wherein the image elements on at least one side of the substrate are selected from the group consisting of: printed image elements, embossed image elements, diffractive structures, and sub-wavelength structures.

61. An optical security device according to claim 57, wherein:
the repeating image elements on at least one side of the substrate are non-diffractive image elements surrounded by a background area comprising a diffractive or sub-wavelength grating structure; and
a background region of the image visible when viewing the device from that side exhibits a colored optically variable effect.

62. A method of manufacturing a security device, the method comprising the steps of:
forming at least one first array of repeating elements at least one of in or on a first side of a transparent or translucent substrate; and
forming at least one second array of repeating elements at least one of in or on a second side of the substrate,
wherein:
the at least one second array of repeating elements is substantially in register with the at least one first array of repeating elements, such that, when viewing the device from the first side, a first image is visible, and when viewing the device from the second side, a second image is visible; and
the repeating elements on at least one side of the substrate are modulated region-wise according to at least one of a brightness or a color level of corresponding regions of an input greyscale or colored image.

63. A method according to claim 62, further comprising the step of modulating the repeating elements on at least one side of the substrate region-wise according to the brightness or color levels of an input greyscale or colored image.

64. A method according to claim 62, further comprising the step of printing the repeating elements on both sides of the substrate to form repeating image elements, wherein Simultan printing is used to form the repeating image elements.

65. A method of manufacturing a security device, the method comprising the steps of:
forming an array of focusing elements in or on a first side of a transparent or translucent substrate; and
forming at least one array of repeating image elements having substantially identical shape to each other in or on a second side of the substrate,
wherein:
the array of repeating image elements is substantially in register with the array of focusing elements; and
the image elements are modulated region-wise according to the brightness or color levels of corresponding regions of an input greyscale or colored image, such that, when viewing the device from the first side, a magnified image including at least one magnified version of the image element shape is visible, and when viewing the device from the second side, the greyscale or colored image is visible.

66. A method according to claim 65, further comprising the steps of:
applying an embossable radiation-curable ink to the first side and/or the second side;
embossing the focussing elements in the embossable radiation-curable ink on the first side or on the second side; and
curing the embossable radiation-curable ink.

67. A security document including a security device according to claim 46.

68. A security document according to claim 67 wherein the security device is at least one of formed in or applied to a window of the security document.
